(19) United States
(12) Patent Application Publication
(10) Pub. No.: US 2006/0263119 A1
(43) Pub. Date: Nov. 23, 2006

(54) Image transferring unit and electrophotographic image forming apparatus having the same

(75) Inventors: Jeong-hwan Kim, Gunsan-si (KR); Myung-ho Kyung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/327,484

(22) Filed: Jan. 9, 2006

(30) Foreign Application Priority Data
May 23, 2005 (KR) 10-2005-0043217

(51) Int. Cl. G03G 15/01; G03G 15/16

(52) U.S. Cl. 399/299; 399/303; 399/313

(57) ABSTRACT

An image transfer unit and an electrophotographic image forming apparatus having the image transfer unit are provided. The image transfer unit includes a photosensitive medium on which an electrostatic latent image is formed and a toner image is formed by toner supplied to the electrostatic latent image. A transfer belt circulates around at least a pair of rollers to form a transfer nip with the photosensitive medium. A transfer roller is arranged opposite to the photosensitive medium with respect to the transfer belt and contacts the transfer belt. The transfer roller is located further upstream of a direction in which the transfer belt proceeds than the photosensitive medium.

### CROSS-REFERENCE TO RELATED PATENT APPLICATIONS

This application claims the benefit under 35 U.S.C. §119(a) of Korean Patent Application No. 10-2005-0043217, filed on May 23, 2005, in the Korean Intellectual Property Office, the entire disclosure of which is hereby incorporated by reference.

### BACKGROUND OF THE INVENTION

1. Field of the Invention

The present invention relates to an electrophotographic image forming apparatus. More particularly, the present invention relates to an image transferring unit for improving the quality of a toner image that is transferred from a photosensitive medium to a print paper, and an electrophotographic image forming apparatus having the same.

2. Description of the Related Art

In general, electrophotographic image forming apparatuses (such as laser printers or digital copiers) print an image by scanning light onto a photosensitive medium that is charged to a predetermined electric potential to form an electrostatic latent image on the outer circumferential surface of the photosensitive medium. A developing agent such as toner is supplied to the electrostatic latent image to develop a visible toner image. The developed image is transferred to a print paper and the transferred image is fused onto the paper.

FIG. 1 is a cross sectional view of a portion of a conventional image transfer unit. Referring to FIG. 1, a conventional image transfer unit 10 includes a photosensitive medium 11, a transfer belt 13 that circulates while being supported by a plurality of rollers (not shown) and a transfer roller 15 that is arranged opposite to the photosensitive medium 11 with respect to the transfer belt 13. A print paper P that is charged due to electrostatic induction is attached to a surface of the transfer belt 13 and moved upwardly. The transfer roller 15 presses the transfer belt 13 against the photosensitive medium 11 to form a transfer nip N between the transfer belt 13 and the photosensitive medium 11.

In the conventional image transfer unit 10, an imaginary line L connecting the axis of the photosensitive medium 11 and the axis of the transfer roller 15 is perpendicular to the direction that the print paper P proceeds. In this structure, the length of the transfer nip N is relatively short, and therefore, the quality of a transferred toner image is deteriorated.

Accordingly, there is a need for an image transfer unit having an improved structure for transferring images, and an image forming apparatus having the same.

### SUMMARY OF THE INVENTION

An aspect of the present invention is to address at least the above problems and/or disadvantages and to provide at least the advantages described below. Accordingly, an aspect of the present invention is to provide an image transfer unit that has an improved structure with a wide transfer nip that prevents reverse transfer of an image, and an electrophotographic image forming apparatus having the same.

According to an aspect of the present invention, an image transfer unit comprises a photosensitive medium on which an electrostatic latent image is formed. A toner image is formed by supplying toner to the electrostatic latent image. A transfer belt circulates around at least a pair of rollers to form a transfer nip with the photosensitive medium. A transfer roller is arranged opposite to the photosensitive medium with respect to the transfer belt and contacts the transfer belt. The transfer roller is located further upstream (a direction opposite to the direction in which the print paper proceeds) on the transfer belt than the photosensitive medium.

The transfer belt may transfer a print paper by allowing the print paper to adhere to a surface of the transfer belt.

An angle “Φ” between a first imaginary line extending from the axis of the photosensitive medium perpendicularly to the direction in which the transfer belt proceeds and a second imaginary line extending from the axis of the photosensitive medium to the axis of the transfer roller may be between 0°-16°.

The sheet resistance ρₛ of the transfer belt may be substantially between 9.0-13.5 Log[Ω/sq]. The volume resistance ρᵥ of the transfer belt may be substantially between 9.0-12.3 Log[Ω].

A plurality of photosensitive media on which toner images having different colors may be provided, and the same number of transfer rollers as that of the photosensitive media may be provided.

According to another aspect of the present invention, an electrophotographic image forming apparatus comprises an optical scanner that scans light corresponding to an image to be printed onto the image. An image transfer unit includes a photosensitive medium on which an electrostatic latent image is formed. A toner image is formed by supplying toner to the electrostatic latent image. A transfer belt circulates around at least a pair of rollers to form a transfer nip with the photosensitive medium. A transfer roller is arranged opposite to the photosensitive medium with respect to the transfer belt and contacts the transfer belt. The transfer roller is located further upstream on the transfer belt than the photosensitive medium.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a cross sectional view of a portion of a conventional image transfer unit;

FIG. 2 is a cross sectional view of an electrophotographic image forming apparatus according to an exemplary embodiment of the present invention;

FIG. 3 is a cross sectional view of an image transfer unit according to an exemplary embodiment of the present invention in which the transfer roller is located a predetermined distance upstream from the photosensitive medium;

FIG. 4 is a cross sectional view of the image transfer unit in which the transfer roller is located a predetermined distance downstream from the photosensitive medium;

FIGS. 5 and 6 are enlarged cross sectional views of the image transfer units shown in FIGS. 3 and 4 for explaining the difference in transfer characteristics of the image transfer units;

FIG. 7 is a view for explaining the cross-sectional geometry of the image transfer unit used in a test for checking the difference in transfer characteristics according to the position of the transfer roller;

FIG. 8 is a graph showing the difference in reverse transfer measured using an optical density meter; and

FIG. 9 is a graph showing an area of the transfer belt indicating a superior transfer characteristic.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

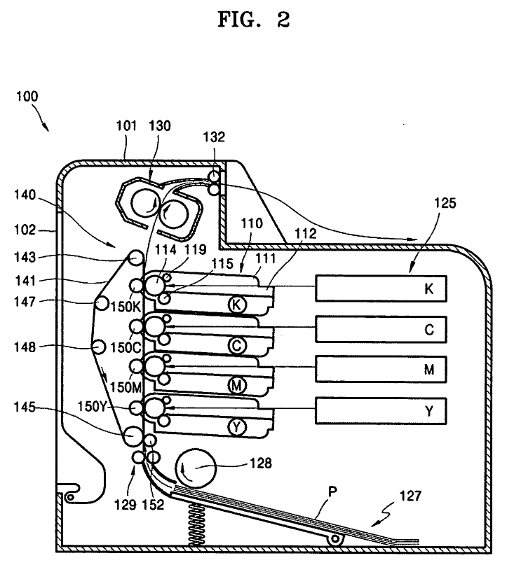

Referring to FIG. 2, an electrophotographic image forming apparatus 100 according to an exemplary embodiment of the present invention is a direct transfer type color image forming apparatus in which images of different colors are sequentially transferred to a print paper P to overlap one another so that a color image is formed directly on the print paper P. The electrophotographic image forming apparatus 100 includes, in a case 101, four developing units 110Y, 110M, 110C, and 110K, four optical scanners 125Y, 125M, 125C, and 125K, an image transfer unit 140 including a transfer belt 141, a fusing unit 130, a paper feed cassette 127 where the print paper P is loaded, a pickup roller 128 for picking up print paper P sheet by sheet from the paper feed cassette 127, a transfer roller 129 for transferring the picked up paper, and a paper eject roller 132 for ejecting printed paper out of the case 101.

The developing unit 110 is a cartridge type unit so that when toner is used up, the used cartridge may be replaced by a new cartridge. In the exemplary embodiment shown in FIG. 2, there are four developing units 110Y, 110M, 110C, and 110K that contain different color toners, for example, yellow (Y), magenta (M), cyan (C), and black (K) toners, for printing a color image. The image transfer unit 140 is engaged with a door 102 at the surface of the case 101. When the door 102 is opened, the developing units 110Y, 110M, 110C, and 110K are arranged horizontally so that they can be replaced.

In the present exemplary embodiment, four optical scanners 125Y, 125M, 125C, and 125K are provided corresponding to the four developing units 110Y, 110M, 110C, and 110K. The optical scanners 125Y, 125M, 125C, and 125K respectively scan light corresponding to Y, M, C, and K image information onto photosensitive media 114Y, 114M, 114C, and 114K (which are installed in developing unit housings 111Y, 111M, 111C, and 111K). Laser scanning units (LSUs) using a laser diode as a light source can be employed as the optical scanners 125Y, 125M, 125C, and 125K.

The developing units 110Y, 110M, 110C, and 110K include the photosensitive media 114Y, 114M, 114C, and 114K and developing rollers 115Y, 115M, 115C, and 115K in the housings 111Y, 111M, 111C, and 111K. The outer circumferential surface of each of the photosensitive media 114Y, 114M, 114C, and 114K facing the transfer belt 141 during image printing is partially exposed to the outside of each of the housings 111Y, 111M, 111C, and 111K, to transfer an image. The developing units 110Y, 110M, 110C, and 110K include charge rollers 119Y, 119M, 119C, and 119K, respectively. A charge bias is applied to each of the charge rollers 119Y, 119M, 119C, and 119K to charge the outer circumferential surface of the photosensitive media 114Y, 114M, 114C, and 114K to a uniform electric potential.

The developing rollers 115Y, 115M, 115C, and 115K supply toner to the photosensitive media 114Y, 114M, 114C, and 114K by allowing the toner to adhere to the outer circumferential surface of the developing rollers 115Y, 115M, 115C, and 115K. A development bias for supplying the toner to the photosensitive media 114Y, 114M, 114C, and 114K is applied to each of the developing rollers 115Y, 115M, 115C, and 115K. Although not shown in FIG. 2, a supply roller for supplying the toner to the developing rollers 115Y, 115M, 115C, and 115K, a doctor blade for limiting the quantity of the toner adhering to the developing rollers 115Y, 115M, 115C, and 115K, and an agitator for agitating the toner contained in the housings 111Y, 111M, 111C, and 111K so that is does not harden and for transferring the toner toward the supply roller are further provided in the housings 111Y, 111M, 111C, and 111K. The developing units 110Y, 110M, 110C, and 110K in the present exemplary embodiment include openings 112Y, 112M, 112C, and 112K that form paths through which the light emitted by the optical scanners 125Y, 125M, 125C, and 125K are scanned onto the photosensitive media 114Y, 114M, 114C, and 114K.

The image transfer unit 140 includes the four photosensitive media 114Y, 114M, 114C, and 114K, and a first roller 143 that is a drive roller, a second roller 145 that is a driven roller arranged in parallel under the first roller 143, the transfer belt 141 that circulates around the first and second roller 143 and 145, four transfer rollers 150Y, 150M, 150C, and 150K arranged between the first roller 143 and the second roller 145, and auxiliary support rollers 147 and 148 for supporting the transfer belt 141. The four transfer rollers 150Y, 150M, 150C, and 150K are arranged opposite to the four photosensitive media 114Y, 114M, 114C, and 114K with the transfer belt 141 interposed therebetween. A transfer bias is applied to each of the transfer rollers 150Y, 150M, 150C, and 150K.

Also, the image transfer unit 140 includes a paper suction roller 152 located opposite to the second roller 145 with the transfer belt 141 interposed therebetween. The paper suction roller 152 charges the print paper P picked up from the paper feed cassette 127 and transferred upwardly by electrostatic induction, so that the print paper P adheres to the surface of the transfer belt 141.

In the process of forming a color image in the electrophotographic image forming apparatus 100, the photosensitive media 114Y, 114M, 114C, and 114K are charged to a uniform electric potential by the charge bias applied to the charge rollers 119Y, 119M, 119C, and 119K. The four optical scanners 125Y, 125M, 125C, and 125K respectively scan light beams corresponding to Y, M, C, and K image information onto the photosensitive media 114Y, 114M, 114C, and 114K. Accordingly, an electrostatic latent image is formed on the outer circumferential surface of each of the photosensitive media 114Y, 114M, 114C, and 114K. The development bias is applied to each of the developing rollers 115Y, 115M, 115C, and 115K. The toner is then moved from the developing rollers 115Y, 115M, 115C, and 115K to the outer circumferential surfaces of the photosensitive media 114Y, 114M, 114C, and 114K. Thus, Y, M, C, and K visible toner images are developed on the outer circumferential surfaces of the photosensitive media 114Y, 114M, 114C, and 114K.

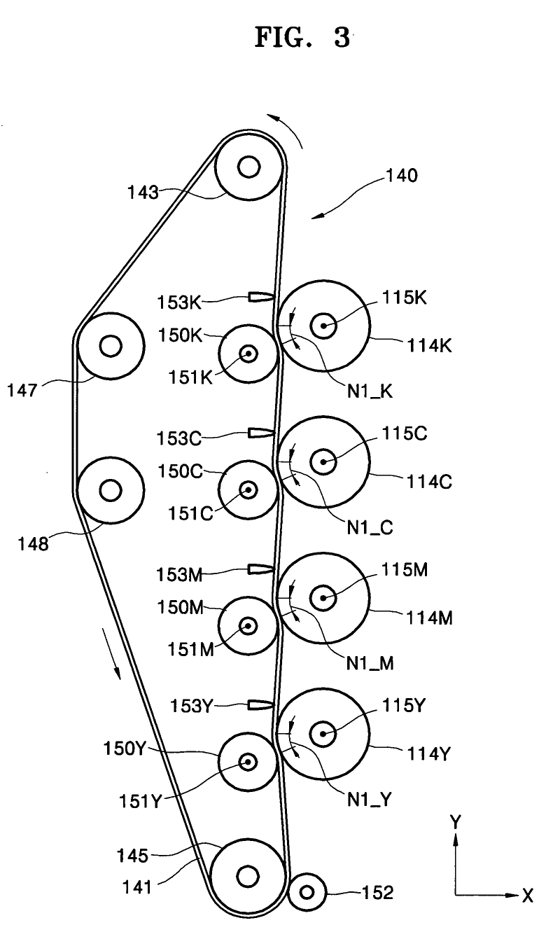

The print paper P is picked up by the pickup roller 128 from the paper feed cassette 127 and transferred upward by the transfer roller 129. When a predetermined voltage is applied to the paper suction roller 152, the print paper P is charged due to the electrostatic induction and adheres to the surface of the transfer belt 141. The print paper P is transferred at the same velocity as the linear velocity of the circulating transfer belt 141. A transfer nip N1_Y (refer to FIG. 3) is formed between the transfer roller 150Y and the transfer belt 141. The leading end of the print paper P arrives at the transfer nip N1_Y at about the same time that the leading end of the yellow visible image formed on the outer circumferential surface of the photosensitive medium 114Y located at the lowermost position arrives at the transfer nip N1_Y. When the transfer bias is applied to the transfer roller 150Y, the toner image formed on the photosensitive medium 114Y is transferred to the print paper P. As the print paper P is transferred, the M, C, and K toner images respectively formed on the outer circumferential surfaces of the photosensitive media 114M, 114C, and 114K are sequentially transferred to the print paper P to overlap one another, thus forming a color image on the print paper P. The fusing unit 130 applies heat and pressure to the color image formed on the print paper P so that color image is fixed to the print paper P. The print paper P with a fixed image is ejected by the paper eject roller 132 out of the case 101.

Referring to FIG. 3, the transfer rollers 150Y, 150M, 150C, and 150K of the image transfer unit 140 are respectively located upstream of the corresponding photosensitive media 114Y, 114M, 114C, and 114K. In other words, the transfer rollers 150Y, 150M, 150C, and 150K are located a predetermined distance away from the corresponding photosensitive media 114Y, 114M, 114C, and 114K in a direction opposite to a direction Y in which the print paper P proceeds. In detail, the axes 151Y, 151M, 151C, and 151K of the transfer rollers 150Y, 150M, 150C, and 150K are located under the axes 115Y, 115M, 115C, and 115K of the photosensitive media 114Y, 114M, 114C, and 114K. The outer circumferential surface of each of the photosensitive media 114Y, 114M, 114C, and 114K is separated by the thickness of the transfer belt 141 from the outer circumferential surface of each of the transfer rollers 150Y, 150M, 150C, and 150K. As a result, the transfer belt 141 is supported by the transfer rollers 150Y, 150M, 150C, and 150K and contacts the photosensitive media 114Y, 114M, 114C, and 114K along the curves of the outer circumferential surfaces of the photosensitive media 114Y, 114M, 114C, and 114K. Thus, the transfer nips N1_Y, N1_M, N1_C, and N1_K are wider than the transfer nips in conventional image forming apparatuses. The image transfer unit 140 includes discharge units 153Y, 153M, 153C, and 153K above the transfer rollers 150Y, 150M, 150C, and 150K. The discharge units 153Y, 153M, 153C, and 153K discharge the transfer belt 141 charged by the transfer bias after the transfer of the toner image

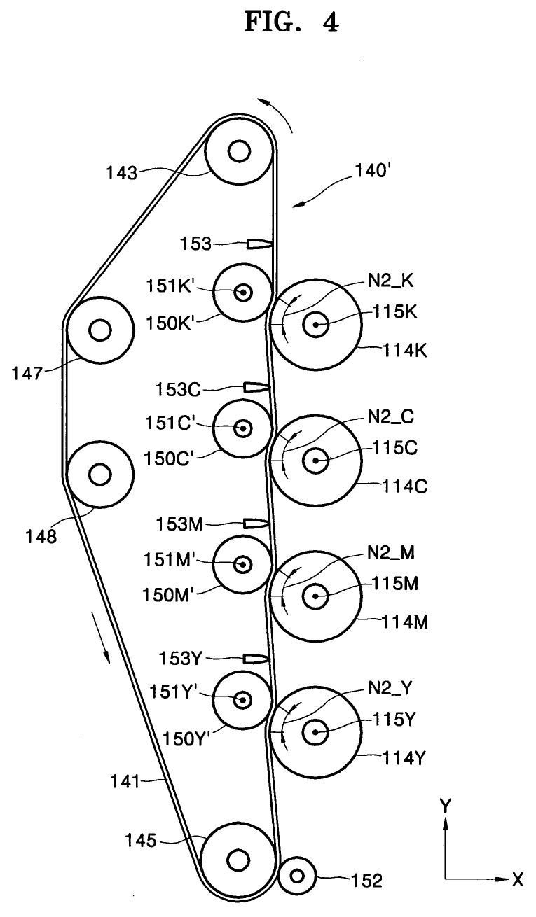

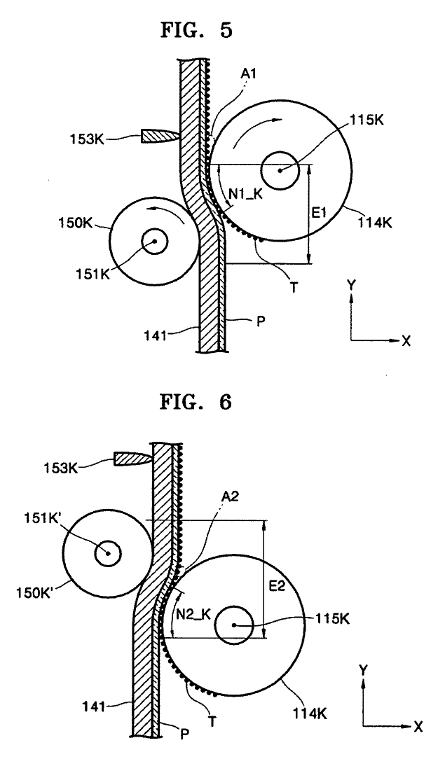

FIG. 4 is a cross sectional view of the image transfer unit in which the transfer roller is located a predetermined distance downstream (that is, the direction in which the print paper proceeds) from the photosensitive medium. FIGS. 5 and 6 are enlarged cross sectional views of certain parts of the image transfer units shown in FIGS. 3 and 4 that help explain why the transfer characteristics of the two units are different.

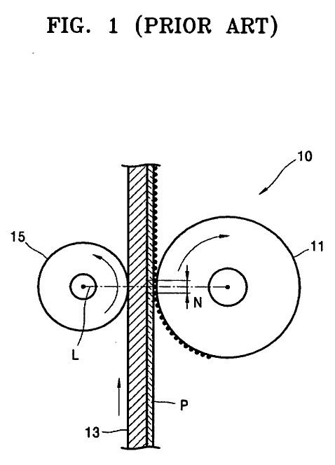

If the extension of a transfer nip is the sole object of the present invention, the transfer rollers 150Y′, 150M′, 150C′, and 150K′ can be installed at positions a predetermined distance downstream from the photosensitive media 114Y, 114M, 114C, and 114K, as shown in FIG. 4. When the axes 151Y′, 151M′, 151C′, and 151K′ of the transfer rollers 150Y′, 150M′, 150C′, and 150K′ are located above the axes 115Y, 115M, 115C, and 115K of the photosensitive media 114Y, 114M, 114C, and 114K as shown in FIG. 4, wider transfer nips N2_Y, N2_M, N2_C, and N2_K than conventional transfer nips (as shown in FIG. 1) can be obtained (as shown in FIG. 3). However, the image transfer unit 140′ having the structure shown in FIG. 4 (that is, a structure with a transfer roller downstream of the photosensitive medium) has poor reverse transfer characteristics, as will be explained in detail below.

Referring to FIG. 5, the print paper P proceeds upwardly and the axis 151K of the transfer roller 150K is located under the axis 115K of the photosensitive medium 114K. An electric field is formed in the transfer belt 141 as the transfer bias is applied to the transfer roller 150K during the transfer process. In particular, the electric field is strongly formed in a first transfer electric field area E1 from a predetermined point before a start point of the transfer nip N1_K to an end point of the transfer nip N1_K. The toner T on the outer circumferential surface of the photosensitive medium 114K is smoothly transferred to the print paper P by the pressure at the transfer nip N1_K and the electrostatic force in the first transfer electric field area E1. The print paper P and the photosensitive medium 114K separate from each other at a point A1 after the transfer nip N1_K.

However, since the point A1 where the print paper P and the photosensitive medium 114K separate from each other is located out of the first transfer electric field area E1, interference by the transfer electric field is not significant at the point A1 and little reverse transfer occurs. Reverse transfer refers to the transfer of Y, M, and C toners that are already transferred to the print paper P back to the photosensitive medium 114K from the print paper P. This is opposite to forward transfer, where the toner T is transferred from the photosensitive medium 114K to the print paper P. Accordingly, in the image transfer unit 140 as shown in FIG. 3, forward transfer is smoothly performed and little reverse transfer occurs, so that the quality of an image being transferred is improved.

Referring to FIG. 6, the print paper P proceeds upwardly and the axis 151K of the transfer roller 150K is located above the axis 115K of the photosensitive medium 114K. A strong transfer electric field is formed in the transfer belt 141 by the transfer bias applied to the transfer roller 150K during the transfer process. This field is formed in a second transfer electric field area E2 from a start point of the transfer nip N2_K to a predetermined point after an end point of the transfer nip N2₋K. The forward transfer of the toner T on the outer circumferential surface of the photosensitive medium 114K is performed smoothly by the pressure at the transfer nip N2₋K and the electrostatic force in the second transfer electric field area E2. The print paper P and the photosensitive medium 114K separate from each other at a point A2 after the transfer nip N2₋K.

In FIG. 6, however, since the point A2 where the print paper P and the photosensitive medium 114K separate is located within the second transfer electric field area E2, interference by the transfer electric field is considerable at the point A2 and severe reverse transfer occurs. Thus, in the image transfer unit 140 shown in FIG. 4, forward transfer is smooth, but reverse transfer is severe, and the quality of an image being transferred is degraded.

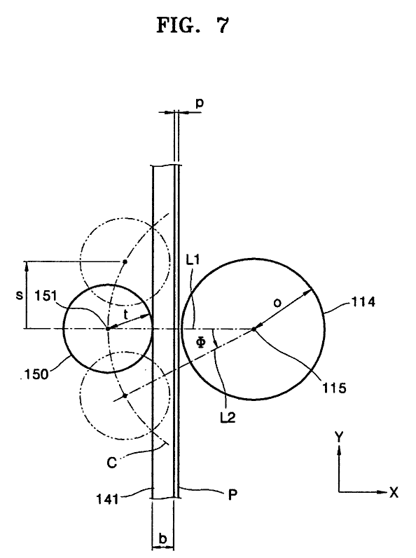

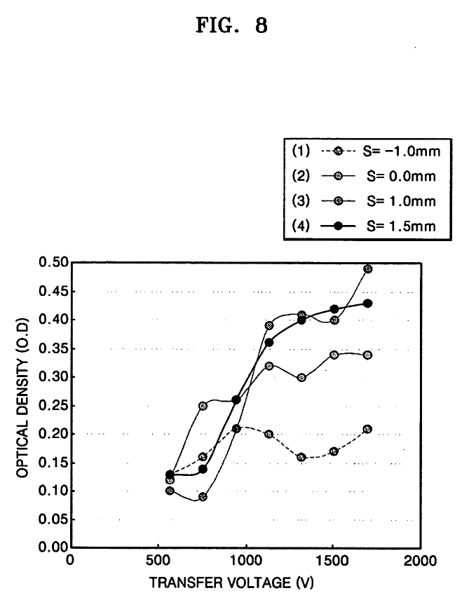

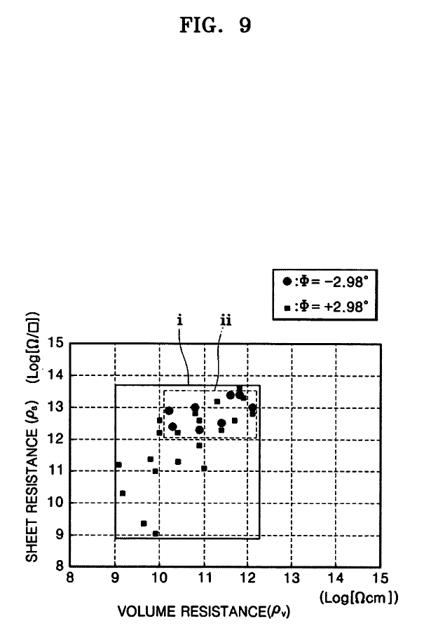

FIG. 7 is a view for explaining the cross-sectional geometry of an image transfer unit used in a test performed by the present inventor to check the difference in the transfer characteristics according to the position of the transfer roller. FIG. 8 is a graph showing the difference in the reverse transfer measured using an optical density meter. FIG. 9 is a graph showing an area of the transfer belt indicating a superior transfer characteristic.

As shown in FIG. 7, the radius of a photosensitive medium 114 is “o”, the radius of a transfer roller 150 is “t”, the thickness of the transfer belt 141 is “b”, and the thickness of the print paper P is “p.” In the image transfer unit used in the test, the values of “o”, “t”, “b”, and “p” were, respectively, 12 mm, 7 mm, 120 μm, and 80 μm. The transfer roller 150 is provided at a position that varies according to a concentric circle C having its center located at the axis 115 of the photosensitive medium 114. The radius of the circle C is equivalent to the distance from the axis 115 of the photosensitive medium 114 to the axis 151 of the transfer roller 150. The amount of a vertical displacement of the transfer roller 150 is “s”, and “s” is defined by a vertical distance from a first imaginary line L1 horizontal to the axis 115 of the photosensitive medium 114 to the position of the axis 151 of the transfer roller 150. The direction in which the transfer roller 150 rises is a positive (+) direction. “Φ” signifies a displacement angle of the transfer roller 150 and is defined by an angle between the first imaginary line L1 and a second imaginary line L2 connecting the axis 115 of the photosensitive medium 114 and the axis 151 of the transfer roller 150. The counterclockwise direction of the transfer roller 150 is a positive (+) direction.

In the graph of FIG. 8, the amount of reverse transfer can be varied by changing the transfer voltage of the transfer roller 150. The amount of reverse transfer can be determined by measuring an optical density. To measure optical density, the toner image transfer process is forcibly terminated. The toner adhering to the outer circumferential surface of the photosensitive medium 114 that is separated from the print paper P after passing the transfer nip is detached from the photosensitive medium 114 using an adhesive tape. Next, light is scanned onto the tape on which the detached toner adheres so that the optical density is measured based on the level of reflected light.

Referring to FIG. 8, line (1) is plotted by setting “s” to −1.0 mm (+2.99° in terms of “Φ”) and measuring the optical density of the K toner reversely transferred to the photosensitive medium 114 of FIG. 7 responsible for development of a K toner image. Line (2) is plotted by setting “s” to 0.0 mm (0° in terms of “Φ”) and measuring the optical density. Lines (3) and (4) are plotted by setting “s” to 1.0 mm and 1.5 mm (respectively −2.99° and −4.48° in terms of “Φ”) and measuring the optical density. It can be seen from FIG. 8 that only Line (1) obtained by locating the transfer roller 150 of FIG. 7 at a position a predetermined distance upstream from the photosensitive medium 150 maintains a superior optical density between 0.1-0.25 within a large transfer voltage range. Lines (3) and (4) obtained by locating the transfer roller 150 at positions downstream from the photosensitive medium 150 show optical densities of 0.35 or more within a transfer voltage range of 1,000 V or more, which shows that the level of reverse transfer is severe.

The result of measuring the levels of the forward transfer and the reverse transfer while varying “s” in a wider range is shown in Table 1.

TABLE 1

| s | Φ | Forward Transfer | Reverse Transfer |
|---|---|---|---|
| +2.0 | −5.98 | Superior | Defective |
| +1.5 | −4.48 | Superior | Defective |
| +1.0 | −2.99 | Superior | Defective |
| +0.5 | −1.49 | Superior | Defective |
| 0 | 0.00 | Normal | Normal |
| −0.5 | +1.49 | Superior | Superior |
| −1.0 | +2.99 | Superior | Superior |
| −1.5 | +4.48 | Superior | Superior |
| −2.0 | +5.98 | Superior | Superior |
| −3.0 | +8.99 | Superior | Superior |
| −4.0 | +12.02 | Superior | Superior |
| −5.0 | +15.09 | Superior | Superior |

In Table 1, it can be seen that, when “Φ” is positive (+), both forward and reverse transfer are superior so that the quality of an image being transferred is improved. Preferably, “Φ” is between 0°-16°. When “Φ” is greater than +16, the curve of the transfer belt 141 of FIG. 7 is severe around the transfer nip so that the leading end of the print paper P can separate from the transfer belt 141. However, if a guide plate or a roller is additionally used to guide the print paper P at the curved portion of the transfer belt 141, even when “Φ” is greater than +16, the quality of an image being transferred can be improved without concern about paper jamming.

The transfer characteristic of the image transfer unit may vary according to the property of the transfer belt 141 of FIG. 7. In particular, the transfer characteristic may vary according to sheet resistance ρₛ and volume resistance ρᵥ. FIG. 9 shows test results regarding sheet resistance ρₛ and volume resistance ρᵥ, and shows that sheet resistance ρₛ and volume resistance ρᵥ are substantially proportionally related. In FIG. 9, the area inside Box i indicates the sheet resistance ρₛ and the volume resistance ρᵥ of the transfer belt 141 that exhibits a superior transfer characteristic when “Φ” is positive (+). The area inside Box ii indicates the sheet resistance ρₛ and the volume resistance ρᵥ of the transfer belt 141 that exhibits a superior transfer characteristic when “Φ” is negative (−). When the sheet resistance ρₛ and the volume resistance ρᵥ of the transfer belt 141 are less than the values corresponding to the left and lower boundaries of Boxes i and ii, charging the transfer belt 141 is difficult, and transfer characteristics are inferior.

FIG. 9 shows that the available design ranges for the transfer belt 141 are increased because the transfer belt area (Box i) when “Φ” is positive (+) is larger than the transfer belt area (Box i) when “Φ” is negative (−). In this example, it can be seen that a transfer belt having a sheet resistance ρₛ of 9.0-13.5 Log[Ω/sq] or a transfer belt having a volume resistance ρᵥ of 9.0-12.3 Log[Ω cm] can be chosen.

As described above, in the image transfer unit according to the present invention and the electrophotographic image forming apparatus having the same, both forward and reverse transfer characteristics are superior. Thus, the overall transfer characteristics are improved and the quality of a printed image is enhanced. Also, since the margin for designing the transfer belt increases, a reliable electrophotographic image forming apparatus can be produced at a low cost.

While the invention has been shown and described with reference to certain exemplary embodiments thereof, it will be understood by those skilled in the art that various changes in form and details may be made therein without departing from the spirit and scope of the invention as defined by the appended claims. For example, the concept of the present invention can be applied to an electrophotographic image forming apparatus using a so-called “intermediary transfer method” in which a toner image is transferred from a photosensitive medium to a transfer belt and then from the transfer belt to a print paper.

What is claimed is:

1. An image transfer unit comprising:
a photosensitive medium on which an electrostatic latent image is formed and a toner image is formed by toner supplied to the electrostatic latent image;
a transfer belt that circulates around at least a pair of rollers to form a transfer nip with the photosensitive medium; and
a transfer roller arranged opposite to the photosensitive medium with respect to the transfer belt, the transfer roller contacting the transfer belt,
wherein the transfer roller is located further upstream on the transfer belt than the photosensitive medium.

2. The unit as claimed in claim 1, wherein
the transfer belt transfers a print paper by allowing the print paper to adhere to a surface of the transfer belt.

3. The unit as claimed in claim 1, wherein
an angle “Φ” between a first imaginary line extending from the axis of the photosensitive medium perpendicularly to the direction that the transfer belt proceeds and a second imaginary line extending from the axis of the photosensitive medium to the axis of the transfer roller is between about 0°-16°.

4. The unit as claimed in claim 1, wherein
a sheet resistance ρₛ of the transfer belt is substantially between 9.0-13.5Log[Ω/sq].

5. The unit as claimed in claim 1, wherein
a volume resistance ρᵥ of the transfer belt is substantially between 9.0-12.3 Log[Ω cm].

6. The unit as claimed in claim 1, further comprising
a plurality of photosensitive media on which toner images having different colors are formed; and
a plurality of transfer rollers corresponding to the plurality of photosensitive media.

7. An electrophotographic image forming apparatus comprising:
an optical scanner that scans light corresponding to an image to be printed; and
an image transfer unit including a photosensitive medium on which an electrostatic latent image is formed by the light scanned by the optical scanner and a toner image is formed by toner supplied to the electrostatic latent image, a transfer belt that circulates around at least a pair of rollers to form a transfer nip with the photosensitive medium, and a transfer roller arranged opposite to the photosensitive medium with respect to the transfer belt, the transfer roller contacting the transfer belt,
wherein the transfer roller is located further upstream on the transfer belt than the photosensitive medium.

8. The apparatus as claimed in claim 7, wherein
the transfer belt transfers a print paper by allowing the print paper to adhere to a surface of the transfer belt.

9. The apparatus as claimed in claim 7, wherein
an angle “Φ” between a first imaginary line extending from the axis of the photosensitive medium perpendicularly to the direction that the transfer belt proceeds and a second imaginary line extending from the axis of the photosensitive medium to the axis of the transfer roller is between about 0°-16°.

10. The apparatus as claimed in claim 7, wherein
a sheet resistance ρₛ of the transfer belt is substantially between 9.0-13.5 Log[Ω/sq].

11. The apparatus as claimed in claim 7, wherein
a volume resistance ρᵥ of the transfer belt is substantially between 9.0-12.3 Log[Ω cm].

12. The apparatus as claimed in claim 7, wherein
a plurality of photosensitive media on which toner images having different colors are formed; and
a plurality of transfer rollers corresponding to the plurality of photosensitive media.

13. An image transfer unit comprising:
a plurality of photosensitive media on which toner images are formed;
a transfer belt that circulates around at least a pair of rollers to form a plurality of transfer nips with respect to the plurality of photosensitive media; and
a plurality of transfer rollers corresponding to the plurality of photosensitive media, each of the plurality of transfer rollers being arranged opposite to one of the plurality of photosensitive media and contacting the transfer belt, each of the transfer rollers being located further upstream on the transfer belt than the photosensitive medium.

14. The apparatus as claimed in claim 13, wherein
an angle “Φ” between a first imaginary line extending from the axis of one of the plurality of photosensitive media perpendicularly to the direction that the transfer belt proceeds and a second imaginary line extending from the axis of one of the plurality the photosensitive media to the axis of a corresponding transfer roller is between about 0°-16°.

15. The apparatus as claimed in claim 13, wherein
a sheet resistance ρₛ of the transfer belt is substantially between 9.0-13.5 Log[Ω/sq].

16. The apparatus as claimed in claim 13, wherein
a volume resistance ρᵥ of the transfer belt is substantially between 9.0-12.3 Log[Ω cm].

17. The apparatus as claimed in claim 13, wherein
toner images having different colors are formed on the plurality of photosensitive media.
